(19) United States
(12) Patent Application Publication
(10) Pub. No.: US 2016/0078535 A1
(43) Pub. Date: Mar. 17, 2016

(54) SYSTEM AND METHOD FOR CROSS-MARKET TRADING OF ETF WITH A SHARE UNDERLYING

(71) Applicant: CSOP ASSET MANAGEMENT LIMITED, Hong Kong (CN)

(72) Inventors: Chen DING, Hong Kong (CN); Yiding WANG, Hong Kong (CN); Lingli ZHOU, Hong Kong (CN); Yan LU, Hong Kong (CN); Guoyan ZHANG, Hong Kong (CN)

(73) Assignee: CSOP ASSET MANAGEMENT LIMITED, Hong Kong (CN)

(21) Appl. No.: 14/484,995

(22) Filed: Sep. 12, 2014

(51) Int. Cl. G06Q 40/04

(52) U.S. Cl. CPC G06Q 40/04

(57) ABSTRACT

The application relates to systems and methods for managing funds. The system is programmed to receive an instruction about a first exchange-traded fund (ETF) in a first exchange system, identify a second ETF according to the instruction in a second exchange system, determine a first underlying currency for the first ETF and a second underlying currency for the second ETF and a currency exchange rate between the first underlying currency and the second underlying currency, obtain an exchange ratio between the first ETF and the second ETF based on the currency exchange rate and components of the first and second ETFs, and exchange a first number of shares of the first ETF to a second number of shares of the second ETF according to the exchange ratio. Thus, the systems and methods allow investors to exchange shares of one ETF to those of another ETF instantly.

### FIELD

The disclosure relates to invest management, especially to systems and methods for managing funds in different markets.

### BACKGROUND

An exchange traded fund (ETF) is an investing tool that is similar to stocks, except that the shares of a given ETF represent an index of stocks, other securities, or other investments rather than a single company stock. Similar to mutual funds, ETFs provide an investor with various types of diversity within a single fund. However, ETFs provide the added benefit of lower expenses, greater transparency, better tax efficiency, and flexibility. For example, unlike mutual or index funds, whose shares may only be bought at the end of the day based on that day's closing price or net asset value on any given day, ETF shares may be purchased intraday, at any time during the trading day, in the same way stocks are traded.

Many ETFs exist in the U.S. For example, the Spider is an ETF that tracks the S&P 500 index, which trades as a stock on the American Stock Exchange. Diamonds (DIA) trades as a stock on the American Stock Exchange and is an index of, or otherwise represents, the thirty stocks in the Dow Jones Industrial Average. Cubes (QQQQ) trades as a stock on the NASDAQ and is an index of, or otherwise represents, the NASDAQ 100.

Similarly, many ETFs exist in Asian markets. For example, Tracker Fund of Hong Kong (TraHK) is an ETF that tracks the Hang Seng Index. CSOP FTSE China A50 ETF tracks the Financial Times Stock Exchange (FTSE) China A50 Index. However, current ETFs are only traded in one market are not tradable when the market is closed. Current ETFs are not flexible to meet the demand of investors who trade in different markets.

### BRIEF DESCRIPTION OF THE DRAWINGS

The systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic diagram illustrating one embodiment of a network environment in which system and methods for managing funds may operate;

FIG. 2 is a schematic diagram illustrating an example embodiment of a client device;

FIG. 3 is a schematic diagram of an example embodiment of a server;

FIGS. 4A-4D illustrate an example structure of fungible funds in different markets; and

FIG. 5 illustrates an example embodiment of a method for managing funds.

### DETAILED DESCRIPTION OF THE DRAWINGS

Subject matter will now be described more fully hereinafter with reference to the accompanying drawings, which form a part hereof, and which show, by way of illustration, specific example embodiments and/or implementations.

Example embodiments and/or implementations of the present application relate to systems and methods for managing funds in different markets. By providing series of exchange-traded funds (ETFs) shares that are fungible have a cross-marketing trading structure that allows shares of the ETFs to be converted with each other, the systems and methods may allow investors to trade after their own secondary market is closed. Comparing to the traditional methods stated above, the systems and methods of the present application provide more flexible ETFs that allow shares of the ETFs in different markets to be converted with each other.

For a better understanding of the present application, hardware environments and online trading environments that example embodiments of the present application may be implemented in are first introduced as follow.

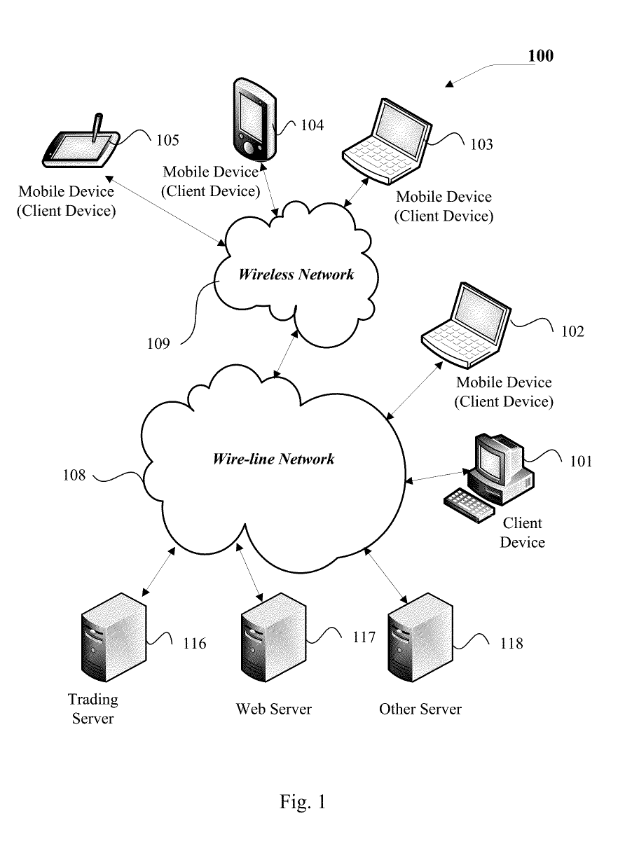

FIG. 1 is a schematic diagram illustrating one embodiment of a network environment in which system and methods for managing funds may operate. Other embodiments of the network environments may vary, for example, in terms of arrangement or in terms of type of hardware components, are also intended to be included within claimed subject matter. In FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., trading server 116 and web server 117) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

The network 100 may also include any form of other implements that connect investors via communications network or via a variety of sub-networks to transmit/share information and to manage/trade funds. For example, the network may include content distribution systems, such as peer-to-peer network, or social network. A peer-to-peer network may be a network employ computing power or bandwidth of network participants for coupling nodes via an ad hoc arrangement or configuration, where the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. Overall, any type of network, traditional or modern, that may facilitate information transmitting, advertising, or trading is intended to be included in the concept of network in the present application.

The trading system may be implemented partially in the servers 116 and 117 and partially in the client devices101-105. For example, the servers may be programmed to process the instructions received at the client devices. The client devices may be programmed to display the account information to the investors. The communications between the servers and the client devices are encrypted to protect the account information of the investors.

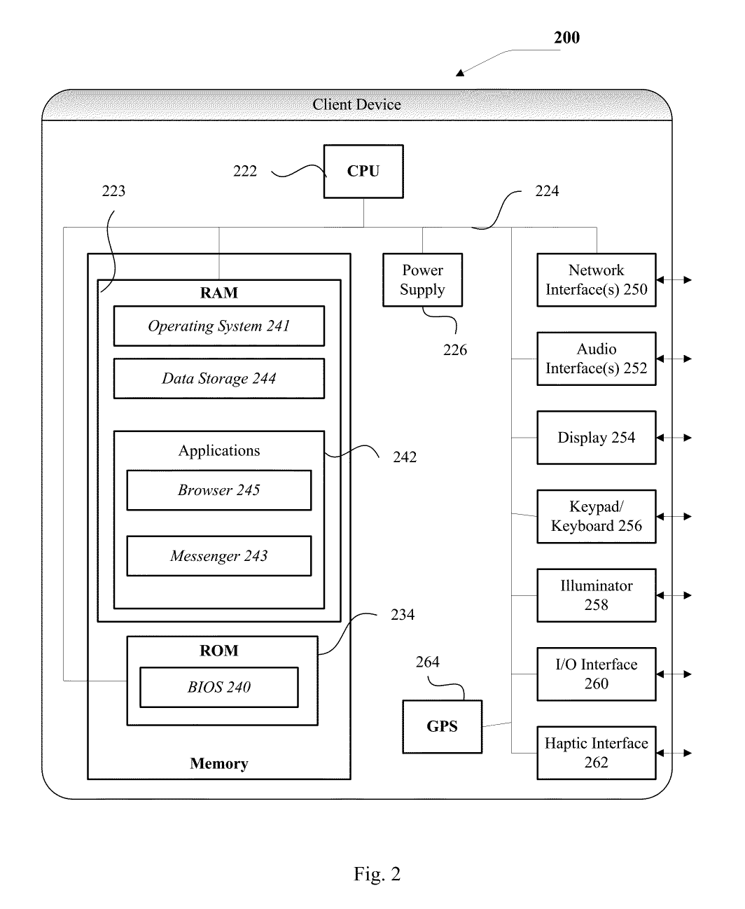

FIG. 2 is a schematic diagram illustrating an example embodiment of a client device, which may be used by investors in managing investment accounts. A client device may include a computing device capable of sending or receiving signals, such as via a wired or a wireless network illustrated in FIG. 1. As shown in FIG. 1, the client device may, for example, include a desktop computer 101 or a portable device 102-105, such as a cellular telephone or a smart phone 104, a display pager, a radio frequency (RF) device, an infrared (IR) device, a Personal Digital Assistant (PDA), a handheld computer, a tablet computer 105, a laptop computer 102-103, a set top box, a wearable computer, an integrated device combining various features, such as features of the forgoing devices, or the like.

A client device may include different hardware configurations and software to provide various capabilities or features. For example, a client device may include a keypad/keyboard 256 or a display 254, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 264 or other location-identifying type capability, or a display with a high degree of functionality, such as a touch-sensitive color 2D or 3D display, for example.

A client device may include or may execute a variety of operating systems 241, including a personal computer operating system, such as a Windows, iOS or Linux, or a mobile operating system, such as iOS, Android, or Windows Mobile, or the like. A client device may include or may execute a variety of possible applications 242, such as a browser 245 and/or a messenger 243. A client application 242 may enable communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games such as fantasy sports leagues. The foregoing is provided to illustrate that claimed subject matter is intended to include a wide range of possible features or capabilities.

For example, an investor may use a client device to access an investment account using a web browser. An investor may also use a specific application that is specifically programmed and optimized for the specific client device to access an investment account. An investor may send instructions to a fund manager through the network between the server and the client device. Similarly, the fund manager may send messages to investors though the network. In this application, an investor may include an individual, a financial institute, or an automated computer system programmed to perform investment activities.

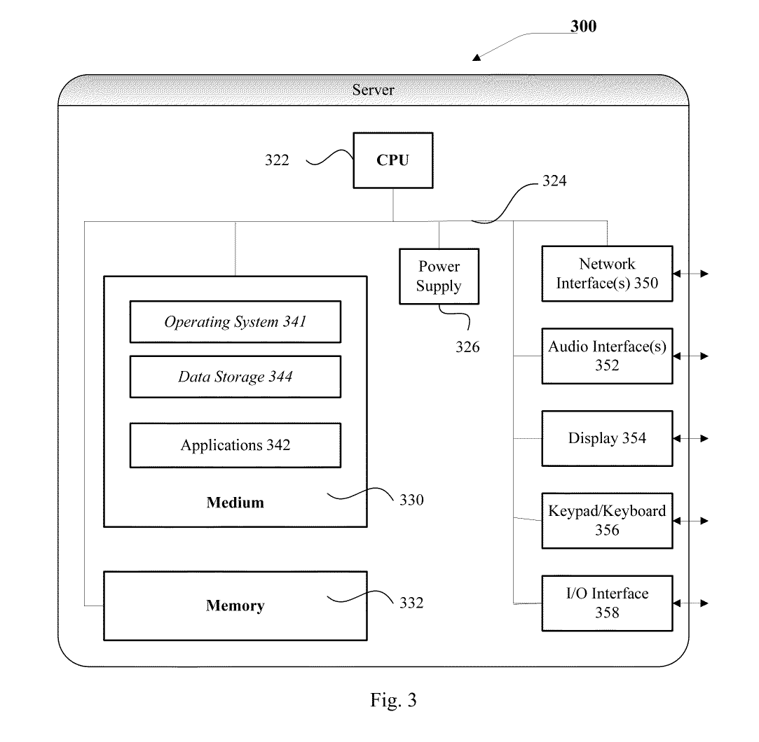

FIG. 3 is a schematic diagram illustrating an example embodiment of a server. A Server 300 may include different hardware configurations or capabilities. For example, a server 300 may include one or more central processing units 322, memory 332 that is accessible to the one or more central processing units 322, one or more medium 630 (such as one or more mass storage devices) that store application programs 342 or data 344, one or more power supplies 326, one or more wired or wireless network interfaces 350, one or more input/output interfaces 358. A server 300 may also include one or more operating systems 341, such as Windows Server, Mac OS X, Unix, Linux, FreeBSD, or the like. Thus, a server 300 may include, as examples, dedicated rack-mounted servers, desktop computers, laptop computers, set top boxes, integrated devices combining various features, such as two or more features of the foregoing devices, or the like.

The server 300 in FIG. 3 may serve as a trading server 116, a web server 117, or other server 118 shown in FIG. 1. A trading server 116 may include a hardware processor such as central processing units 322, for example. A trading server 116 may also include a non-transitory storage medium that is configured to store a set of instructions for managing funds in different markets. The processor is in communication with the non-transitory storage medium that is programmed to execute the set of instructions stored in the non-transitory storage medium and is programmed to: receive an instruction about a first exchange-traded fund (ETF) in a first exchange system; identify a second ETF according to the instruction in a second exchange system; determine a first underlying currency for the first ETF and a second underlying currency for the second ETF and a currency exchange rate between the first underlying currency and the second underlying currency; obtain an exchange ratio between the first ETF and the second ETF based on the currency exchange rate and components of the first and second ETFs; and exchange a first number of shares of the first ETF to a second number of shares of the second ETF according to the exchange ratio.

A web server 117 may include a device that includes a configuration to provide content via a network to another device. A web server may, for example, host a website, such as an investment website, examples of which may include, but are not limited to, stock trading website, fund trading website, bond trading website, future trading website, option trading website, etc. A web server 117 may also host a variety of other sites, including, but not limited to social network sites, educational sites, dictionary sites, encyclopedia sites, wikis, financial sites, government sites, etc. A web server 117 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of web content may include text, images, audio, video, or the like, which may be processed in the form of physical signals, such as electrical signals, for example, or may be stored in memory, as physical states, for example. Examples of devices that may operate as a web server include desktop computers, multiprocessor systems, cloud-based servers, microprocessor type or programmable consumer electronics, etc.

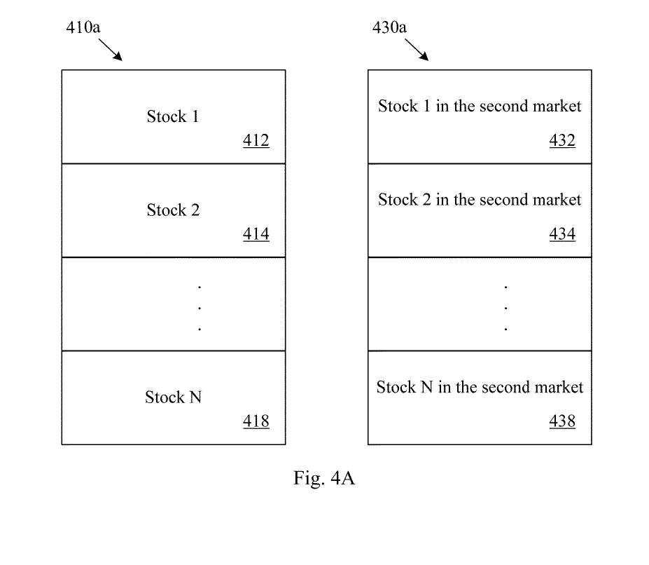

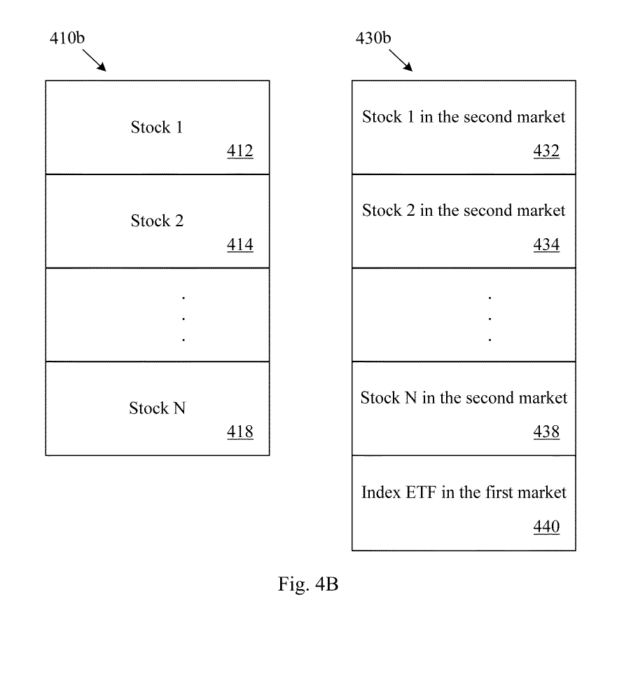

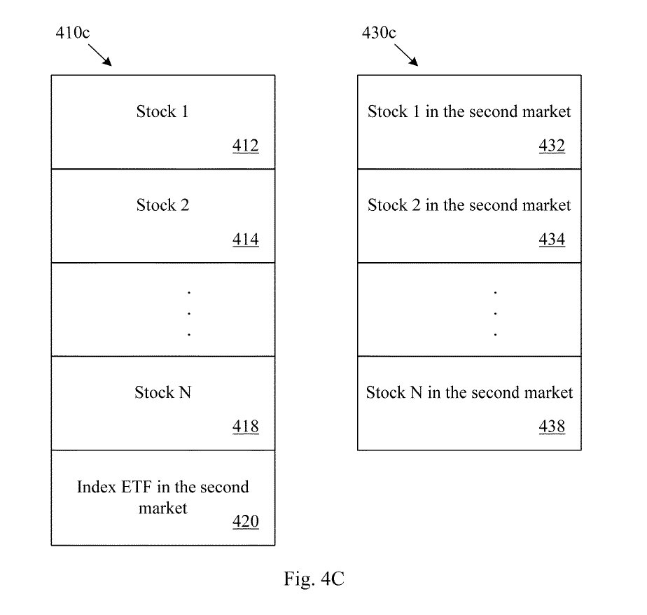

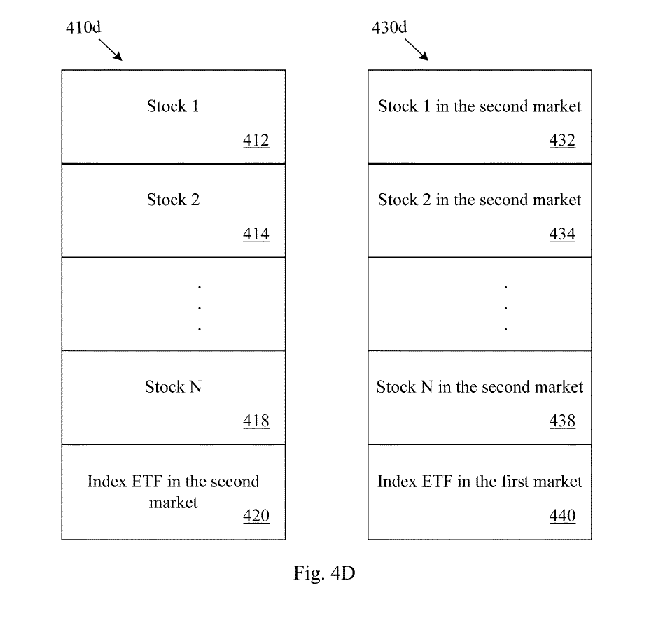

FIGS. 4A-4D illustrate an example structure of fungible funds in different markets, which are also stored in a non-transitory storage medium accessible to the trading server. The fungible funds may include two ETFs in two different markets. FIG. 4A illustrates the two original ETFs 410a and 430a before any ETF is exchanged between the two ETFs. Initially, the two ETFs 410a and 430a track the same index while being traded in two different markets based on different currencies. For example, the first ETF 410a may be an ETF traded in the first market. For example, the first market may be the U.S. market and the first ETF is traded in a first exchange system such as an exchange in the U.S. The first exchange system may include an electronic stock exchange system that provides services for stock brokers and traders to buy or sell stocks, bonds, funds, and other securities. The first ETF 410a may track an index that includes multiple stocks and/or an index in the first market. For example, the first ETF 410a may track an index that includes N stocks: a first stock 412, a second stock 414, and an Nth stock 418. The N stocks may be components of an index in the second market. The first ETF 410a may be based on a first currency such as U.S. dollar, for example.

The second ETF 430a may be an ETF in a second market outside of the U.S. For example, the second ETF 430a may be traded in the Hong Kong Stock Exchange. The second ETF 430a may be traded through a second electronic exchange system connected to the second market. The second ETF 430a may track a second index that includes multiple stocks and/or an index in the second market. The second ETF 430 may be based on a second currency such as Renminbi (RMB), which is the official currency of People's Republic of China (PRC). The stocks and index in the second ETF 430a may correspond to the stocks and index in the first ETF 410a. For example, a second index may include N stocks in the second market: a first stock in the second market 422, a second stock in the second market 424, and an Nth stock in the second market 428. The stocks 412 and 422 may relate to the same company. For example, the stocks 412 and 422 may be the same stock. Alternatively, the stocks 412 and 422 may be related to a company that is traded in both the first and second markets.

FIG. 4B illustrates the two ETFs 410b and 430b after shares of the ETF 410a have been exchanged to shares of the ETF 430a. In this case, an investor in the first market sends a request to the trading server to exchange shares of 410a to shares of 430a. The trading server exchanges the two ETFs without using cash. For example, the trading server may exchange the shares directly based on the exchange ratio between the first ETF and the second ETF. In other words, the trading server provides in-kind creation and in-kind redemption for the first ETF based on the second ETF. After settlement, the first ETF 410b in the first market is the same as the original first ETF 410a. The second ETF 430b, however, now holds shares of an index ETF 440 in the first market. The index ETF 440 may be the first ETF 410a. The trading server may update the corresponding electronic records for the ETFs after each exchange is accomplished.

Similarly, FIG. 4C illustrates the two ETFs 410c and 430c after shares of the ETF 430a have been exchanged to shares of the ETF 410a. In this case, an investor in the second market sends a request to the trading server to exchange shares of 430a to shares of 410a. The trading server exchanges the two ETFs without using cash. For example, the trading server may exchange the shares directly based on the exchange ratio between the first ETF and the second ETF. After settlement, the second ETF 430c in the second market is the same as the original first ETF 430a. The first ETF 410c, however, now holds shares of an index ETF 420 in the second market. The index ETF 420 may be the second ETF 430a.

FIG. 4D illustrates the two ETFs 410d and 430d after shares of the ETF 410a have been exchanged to shares of the ETF 430a following shares of the ETF 430a have been exchanged to shares of the ETF 410a. In this case, the two ETFs 410d and 430d are blended and both hold shares of the other. After multiple exchanges in two directions, the first ETF 410d holds index ETF 420 in addition to the original stock holdings in 410a. Similarly, the second ETF 430d holds index ETF 440 in addition to the original stock holdings in 410a. By using the direct exchange without cash redemption and share-buyback, the fund management system may enable investors to trade around the clock when one of the secondary markets is closed.

In this application, the fund management system is connected to clearing systems in both markets so that the ETF shares may be exchanged and settled easily. The clearing systems may include the Central Clearing and Settlement System (CCASS) in Hong Kong and the National Securities Clearing Corporation (NSCC) in the U.S. By directly dealing with two clearing systems in different markets, the funds management system sends instructions to the clearing system directly so that in-kind creation and redemption of the ETF can be accomplished. The funds management system thus provides a novel settlement scheme that exchanges the two ETFs in different markets directly.

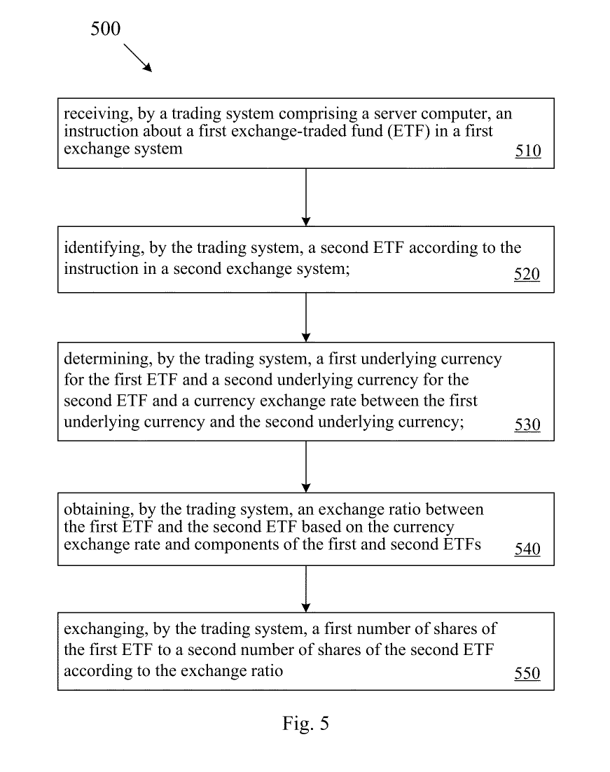

FIG. 5 illustrates an example embodiment of a method 500 for managing funds. However, it should be appreciated that the systems and methods described here are not limited to use with the exact example embodiments. The method 500 includes the following acts implemented by a fund management system in the network 100 illustrated in FIG. 1. The fund management system may include a trading system which includes at least one of the servers and terminal devices in FIG. 1.

In one example embodiment, the trading server 160 in FIG. 1 may be programmed to perform the following acts illustrated in FIG. 5.

In act 510, a trading system receives an instruction about a first ETF in a first exchange system. The trading system may receive the instruction sent from a client device as illustrated in FIG. 1. The instruction may include identification of the first ETF in a first exchange system. The instruction may further include a second identification of a second ETF in a second exchange system. For example, the first ETF may be CSOP FTSE China A50 ETF (listed in New York) and the second ETF may be CSOP FTSE China A50 ETF (listed in Hong Kong). The first ETF may be traded in a stock exchange based on U.S. dollars and the second ETF may be traded in a foreign exchange based on RMB. The instruction may further include an identification of the clearing system and a bank account related to the fund manager of the ETF.

Here, the FTSE China A50 Index is a free float-adjusted market capitalization-weighted index compiled and published by FTSE International Limited (“FTSE”) and is a real-time, tradable index comprising of the largest 50 A-Share companies by full market capitalization. The FTSE China A50 index offers an optimal balance between representativeness and tradability for China's A-Share market. It is a price return index and includes securities listed on both the Shanghai and Shenzhen security exchanges in China. The ETF operating cost may include Management Fee, Trustee Fee, and other expenses. Compared with other ETFs, the CSOP FTSE China A50 ETF listed in Hong Kong may be traded in both RMB and HK dollar. Further, the CSOP FTSE China A50 ETF invest directly in A-shares that replicate or represent the composition of the underlying A-share index in China. The CSOP FTSE China A50 ETF adopts physical full replication or representative sampling, which directly invest in the Mainland China securities markets through RQFII investment quota, where RQFII means the RMB Qualified Foreign Institutional Investors scheme. Thus, the CSOP A50 ETF directly tracks the performance of the underlying index by directly investing in the constituent securities of the underlying index which are solely A-Shares. However, the CSOP A50 ETF itself is listed on the Hong Kong Exchanges and Clearing Limited. A cross-border flow of money may occur in the investment process.

In this application, RQFII refers to a new policy initiative of the Mainland authorities which allows qualified RQFII holders to channel RMB funds raised in Hong Kong to be invested into the securities markets in PRC. RQFII holders may issue public or private fund or other investment products using their RQFII quotas. RQFII funds give retail investors access to invest in PRC securities markets as they can invest RMB directly into the PRC bond and equity markets (including the inter-bank bond and exchange-traded bond market) through the RQFII quotas. Subscriptions and redemptions of units in the fund must be settled and paid in RMB.

In act 520, a trading system identifies a second ETF according to the instruction in a second exchange system. Based on the ETF identification in the instruction, the trading system identifies a second ETF that tracks similar portfolio or the same index as the first ETF. The second ETF may be traded based on multiple currencies. For example, the second ETF may be traded based on RMB and Hong Kong dollar. Note that RMB is not a freely convertible currency while Hong Kong dollar is a freely convertible currency.

In act 530, a trading system determines a first underlying currency for the first ETF and a second underlying currency for the second ETF and obtains a currency exchange rate between the first underlying currency and the second underlying currency. After identifying the second ETF in the second exchange system, the trading system may determine the first underlying currency for the first ETF and the second underlying currency for the second ETF. A trading system may be connected via a network connection to a database that includes the foreign currency exchange rate between the first currency and the second currency. Alternatively or additionally, the trading system may be connected to another trading system that provides currency exchange rate information for multiple currencies.

In act 540, a trading system obtains an exchange ratio between the first ETF and the second ETF based on the currency exchange rate and components of the first and second ETFs. After obtaining the currency exchange rate, the trading system may obtain an exchange ratio between the first ETF and the second ETF based on the currency exchange rate. For example, if the currency exchange rate between the first currency and the second currency is 1:X, the exchange ratio between the first ETF and the second ETF may be 1:X, where X is a positive number. If the first currency is U.S. dollar and the second currency is RMB, the exchange ratio X between the first ETF and the second ETF may be 1:6.15 (i.e. 1 USD is equivalent to 6.15 RMB) if the two ETFs are tracking the same index.

In act 550, a trading system exchanges a first number of shares of the first ETF to a second number of shares of the second ETF according to the exchange ratio. After obtaining the exchange ratio between the two ETFs, the trading system calculate the value of the first number of ETF in the second currency and then exchanges share of first ETF to shares of second ETF. For example, the trading system may exchange the first number of shares of the first ETF to the second number of shares of the second ETF according to the exchange ratio in real time. That means the whole exchange acts may be accomplished electronically within a few seconds. Investors thus may exchange the shares of ETF instantly even while the second market is closed. Because the exchange may be accomplished in real time with a very low transaction cost, investors may use the ETFs for arbitrage strategies with reduced cost. The trading system thus provides in-kind creation and in-kind redemption for the first ETF based on the second ETF. Similarly, the trading system provides in-kind creation and in-kind redemption for the second ETF based on the first ETF. The resulted ETF in one market after settlement may hold shares of the other ETF in the other market in addition to the original security holdings.

The market value of the first number of ETF and the market value of the second number of ETF are the same if the investor is willing to pay any processing fee with additional cash. The processing fee may include a management fee determined by the trading system. The management fee may be determined based on factors including at least one of: the first number of shares of the first ETF identified in the exchange instruction, the total number of shares of the first ETF in the account of the investor, the currency exchange ratio between the first currency and the second currency, any official fee according to relevant government regulations, and any contract agreement between the investor and the fund manager of the two ETFs.

The above acts may also be partially implemented in a cloud-based computing system. Thus, investors may use the cloud-based computing system to exchange shares of one ETF to those of another ETF instantly with low cost. The two ETFs may have similar portfolio or track the same index. Accordingly, investors may finish the exchange around the clock when the second market is closed or even when the salesperson of fund manager is not in office. The systems and methods provide convenience to investors so that investors may sell the shares of the second ETF in secondary market when the second market is open.

In addition, while example embodiments have been particularly shown and described with reference to FIGS. 1-5, it will be understood by one of ordinary skill in the art that various changes in form and details may be made therein without departing from the spirit and scope of example embodiments, as defined by the following claims. The example embodiments, therefore, are provided merely to be illustrative and subject matter that is covered or claimed is intended to be construed as not being limited to any example embodiments set forth herein. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof. The following detailed description is, therefore, not intended to be taken in a limiting sense.

Compared with existing funds management systems, the disclosed funds management system provides two ETFs separately traded in two different markets, which may be exchanged directly. The direct exchange does not require selling the first ETF in the first market and using the cash from the sale to purchase the second ETF in the second market. Rather, the funds management system adopts in-kind creation/redemption based on ETF in addition to stocks. The funds management system also reduces fee cost involved in the existing ETF management systems. Further, the funds management system offers investor the opportunity to exchange shares of two ETFs when one of the secondary markets for the ETFs is closed. Thus, the disclosed funds management system enables investors to finish the exchange around the clock even the salesperson of fund manager is not in office. After investors get the shares of the second ETF, they may sell the shares of the second ETF in a secondary market when the second market is open.

Throughout the specification and claims, terms may have nuanced meanings suggested or implied in context beyond an explicitly stated meaning. Likewise, the phrase “in one embodiment” or “in one example embodiment” as used herein does not necessarily refer to the same embodiment and the phrase “in another embodiment” or “in another example embodiment” as used herein does not necessarily refer to a different embodiment. It is intended, for example, that claimed subject matter include combinations of example embodiments in whole or in part.

The terminology used in the specification is for the purpose of describing particular embodiments only and is not intended to be limiting of example embodiments of the invention. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Likewise, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof, and in the following description, the same reference numerals denote the same elements.

What is claimed is:

1. A computer-implemented method for managing funds in different markets, comprising:
receiving, by a trading system comprising a server computer, an instruction about a first exchange-traded fund (ETF) in a first exchange system;
identifying, by the trading system, a second ETF according to the instruction in a second exchange system;
determining, by the trading system, a first underlying currency for the first ETF and a second underlying currency for the second ETF and a currency exchange rate between the first underlying currency and the second underlying currency;
obtaining, by the trading system, an exchange ratio between the first ETF and the second ETF based on the currency exchange rate and components of the first and second ETFs; and
exchanging, by the trading system, a first number of shares of the first ETF to a second number of shares of the second ETF according to the exchange ratio.

2. The computer-implemented method according to claim 1, further comprising:
providing in-kind creation and in-kind redemption for the first ETF based on the second ETF.

3. The computer-implemented method according to claim 1, further comprising:
determining, by the trading system, a management fee for exchanging the first number of shares of the first ETF to the second number of shares of the second ETF.

4. The computer-implemented method according to claim 1, wherein the trading system exchanges the first number of shares of the first ETF to the second number of shares of the second ETF according to the exchange ratio when a market corresponding to the second exchange system is closed.

5. The computer-implemented method according to claim 1, wherein the trading system exchanges the first number of shares of the first ETF to the second number of shares of the second ETF according to the exchange ratio in real time.

6. The computer-implemented method according to claim 1, wherein one of the first underlying currency and the second underlying currency is a freely convertible currency.

7. The computer-implemented method according to claim 1, wherein one of the first underlying currency and the second underlying currency is not a freely convertible currency.

8. A non-transitory storage medium comprising a set of instructions for managing funds in different markets, the set of instructions to direct a processor to perform acts comprising:
receiving an instruction about a first exchange-traded fund (ETF) in a first exchange system;
identifying a second ETF according to the instruction in a second exchange system;
determining a first underlying currency for the first ETF and a second underlying currency for the second ETF and a currency exchange rate between the first underlying currency and the second underlying currency;
obtaining an exchange ratio between the first ETF and the second ETF based on the currency exchange rate and components of the first and second ETFs; and
exchanging a first number of shares of the first ETF to a second number of shares of the second ETF according to the exchange ratio.

9. The non-transitory storage medium according to claim 8, wherein the acts further comprising:
providing in-kind creation and in-kind redemption for the first ETF based on the second ETF.

10. The non-transitory storage medium according to claim 8, wherein the acts further comprising:
determining, by the trading system, a management fee for exchanging the first number of shares of the first ETF to the second number of shares of the second ETF.

11. The non-transitory storage medium according to claim 8, wherein exchanging the first number of shares of the first ETF to the second number of shares of the second ETF according to the exchange ratio further comprises:
exchanging the first number of shares of the first ETF to the second number of shares of the second ETF according to the exchange ratio when a market corresponding to the second exchange system is closed.

12. The non-transitory storage medium according to claim 8, wherein exchanging the first number of shares of the first ETF to the second number of shares of the second ETF according to the exchange ratio further comprises:
exchanging the first number of shares of the first ETF to the second number of shares of the second ETF according to the exchange ratio in real time.

13. The non-transitory storage medium according to claim 8, wherein one of the first underlying currency and the second underlying currency is a freely convertible currency.

14. The non-transitory storage medium according to claim 8, wherein one of the first underlying currency and the second underlying currency is not a freely convertible currency.

15. A trading system comprising:
a non-transitory storage medium comprising a set of instructions for managing funds in different markets;
a processor in communication with the non-transitory storage medium that is programmed to execute the set of instructions stored in the non-transitory storage medium and is programmed to:
receive an instruction about a first exchange-traded fund (ETF) in a first exchange system;
identify a second ETF according to the instruction in a second exchange system;
determine a first underlying currency for the first ETF and a second underlying currency for the second ETF and a currency exchange rate between the first underlying currency and the second underlying currency;
obtain an exchange ratio between the first ETF and the second ETF based on the currency exchange rate and components of the first and second ETFs; and
exchange a first number of shares of the first ETF to a second number of shares of the second ETF according to the exchange ratio.

16. The trading system according to claim 15, wherein the first underlying currency and the second underlying currency are different currencies.

17. The trading system according to claim 15, wherein the processor if further programmed to determine a management fee for exchanging the first number of shares of the first ETF to the second number of shares of the second ETF.

18. The trading system according to claim 15, wherein the processor if further programmed to exchange the first number of shares of the first ETF to the second number of shares of the second ETF according to the exchange ratio when a market corresponding to the second exchange system is closed.

19. The trading system according to claim 15, wherein the processor if further programmed to exchange the first number of shares of the first ETF to the second number of shares of the second ETF according to the exchange ratio in real time.

20. The trading system according to claim 15, wherein one of the first underlying currency and the second underlying currency is a freely convertible currency; and
wherein one of the first underlying currency and the second underlying currency is not a freely convertible currency.
